(19) United States
(12) Patent Application Publication
(10) Pub. No.: US 2026/0364655 A1
(43) Pub. Date: Nov. 19, 2026

(54) WASTE TREATMENT SYSTEM

(71) Applicant: MITSUBISHI HEAVY INDUSTRIES, LTD., Tokyo (JP)

(72) Inventors: Haruka Adachi, Tokyo (JP); Koichi Fukunaga, Tokyo (JP); Keiichi Nakagawa, Tokyo (JP); Keiji Fujikawa, Tokyo (JP); Ryo Kamito, Tokyo (JP); Takashi Ike, Tokyo (JP); Masayuki Takeda, Tokyo (JP); Kazuo Yamasaki, Tokyo (JP)

(73) Assignee: MITSUBISHI HEAVY INDUSTRIES, LTD., Tokyo (JP)

(21) Appl. No.: 19/136,757

(22) PCT Filed: Oct. 16, 2023
(86) PCT No.: PCT/JP2023/037329

§ 371 Date: Jun. 6, 2025

(30) Foreign Application Priority Data
Dec. 20, 2022 (JP) 2022-202884

(51) Int. Cl. B09B 3/35; B09B 3/60; B09B 3/70; B09B 5/00

(52) U.S. Cl. CPC B09B 3/35; B09B 3/60; B09B 3/70; B09B 5/00

(57) ABSTRACT

A waste treatment system includes: a shredding device for shredding a waste into a size within a setting range set in advance; a reforming device for producing a reformed material by hydrolyzing the waste shredded by the shredding device; a separation device for separating the reformed material produced by the reforming device into a small-particle component and a large-particle component that has a larger diameter than the small-particle component; and a microbial reaction device for microbially degrading the small-particle component separated by the separation device into a low-molecular-weight component.

### TECHNICAL FIELD

The present disclosure relates to a waste treatment system.

The present application claims priority based on Japanese Patent Application No. 2022-202884 filed on Dec. 20, 2022, the entire content of which is incorporated herein by reference.

### BACKGROUND ART

Some waste treatment systems include a degradation device (e.g., methane fermenter) for microbially degrading suitable substances such as organic substances in waste into low-molecular-weight components. In such waste treatment systems, techniques have been introduced to reduce the mix rate of unsuitable substances (e.g., plastics in waste which cannot be microbially degraded) fed to the degradation device. For example, Patent Document 1 discloses that waste is coarsely shredded by a shredder and then fed into a rotary sorter to sort out suitable substances from the waste. Also, taking advantage of the property that suitable substances tend to be finer than unsuitable substances when hydrolyzed, Patent Document 2 discloses that waste is hydrolyzed in a reforming device and then separated into suitable substances (small-particle component) and unsuitable substances (large-particle component) in a separation device.

### CITATION LIST

### Patent Literature

Patent Document 1: JP2019-177334A

Patent Document 2: JP2022-012974A

### SUMMARY

### Problems to Be Solved

However, in the technique described in Patent Document 1, waste containing suitable and unsuitable substances of similar size is fed into the rotary sorter, which may not be able to remove only unsuitable substances from the waste, resulting in a high mix rate of unsuitable substances. In the technique described in Patent Document 2, the reforming device receives waste as it is, which means that the reforming device receives waste of various sizes. As a result, the particle size of the hydrolyzed waste varies, making it difficult to achieve a good recovery rate of suitable substances and a good mix rate of unsuitable substances in the separation device.

The present disclosure was made in view of the above problem, and an object thereof is to provide a waste treatment system whereby it is possible to achieve a good recovery rate of suitable substances and a good mix rate of unsuitable substances in the separation device.

### Solution to the Problems

In order to achieve the above object, a waste treatment system according to the present disclosure includes: a shredding device for shredding a waste into a size within a setting range set in advance; a reforming device for producing a reformed material by hydrolyzing the waste shredded by the shredding device; a separation device for separating the reformed material produced by the reforming device into a small-particle component and a large-particle component that has a larger diameter than the small-particle component; and a microbial reaction device for microbially degrading the small-particle component separated by the separation device into a low-molecular-weight component.

### Advantageous Effects

With the waste treatment system of the present disclosure, it is possible to achieve a good recovery rate of suitable substances and a good mix rate of unsuitable substances in the separation device.

### BRIEF DESCRIPTION OF DRAWINGS

FIG. 1 is a schematic configuration diagram of a waste treatment system according to the first embodiment.

FIG. 2A is a schematic configuration diagram (side view) of a shredding device according to the first embodiment.

FIG. 2B is a schematic configuration diagram (plan view) of a shredding device according to the first embodiment.

FIG. 3 is a schematic configuration diagram of a separation device according to the first embodiment.

FIG. 4 is a table showing the mix rate of unsuitable substances and the recovery rate of suitable substances corresponding to the ratio of the lower limit of the setting range to the mesh size.

FIG. 5 is a schematic configuration diagram of a sieve (separation device) according to the second embodiment.

FIG. 6 is a schematic configuration diagram of a waste treatment system according to the second embodiment.

FIG. 7 is a perspective view of part of the inside of the sieve according to the third embodiment.

FIG. 8 is a diagram for describing a guide part according to the third embodiment.

### DETAILED DESCRIPTION

Hereinafter, a waste treatment system according to embodiments of the present disclosure will be described with reference to the drawings. The following embodiments are illustrative and not intended to limit the present disclosure, and various modifications are possible within the scope of technical ideas of the present disclosure.

This disclosure describes a case in which a waste treatment system 1 treats waste W such as municipal waste. The municipal waste mainly contains kitchen waste, paper waste, and plastic waste, with a small amount of metal. The waste W is not limited to municipal waste but may be waste such as sludge generated by treating effluent from factories or the like and agricultural waste with a higher moisture content than municipal waste.

### First Embodiment

### (Configuration)

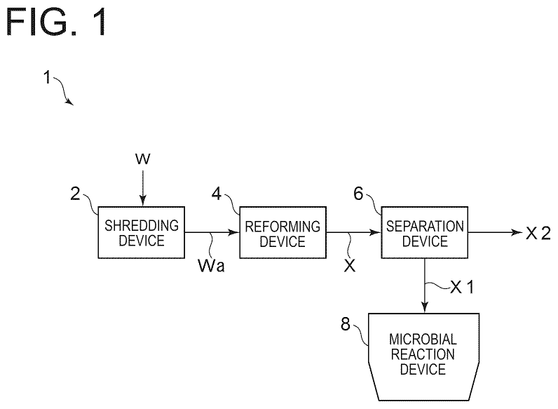

FIG. 1 is a schematic configuration diagram of a waste treatment system 1 according to the first embodiment. As illustrated in FIG. 1, the waste treatment system 1 includes a shredding device 2, a reforming device 4, a separation device 6, and a microbial reaction device 8.

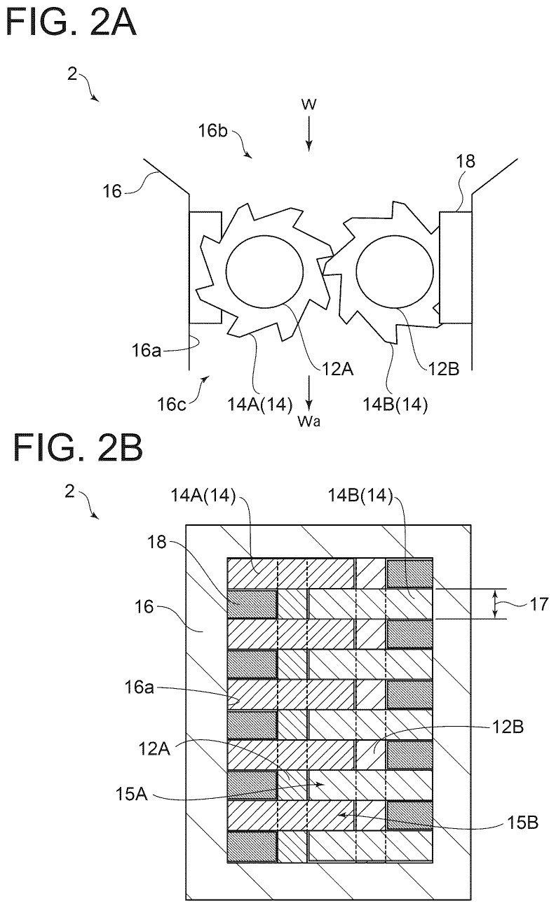

The shredding device 2 will now be described. The shredding device 2 shreds the waste W into a size within a setting range R set in advance. Hereafter, the waste W shredded by the shredding device 2 is referred to as shredded material Wa. FIGS. 2A and 2B are each a schematic configuration diagram of the shredding device 2 according to the first embodiment. FIG. 2A is a side view of the shredding device 2, and FIG. 2B is a top view of the shredding device 2.

As illustrated in FIGS. 2A and 2B, in the first embodiment, the shredding device 2 is a so-called twin-shaft shredder, which includes two drive shafts 12A and 12B arranged side by side, at least one shredding blade 14 provided around the periphery of each of the two drive shafts 12A and 12B, and a casing 16 housing the two drive shafts 12A and 12B and the shredding blades 14.

The two drive shafts 12A and 12B are configured to be driven to rotate in mutually opposite directions by a motor (not shown). Each of the two drive shafts 12A and 12B rotates so that the top surface moves toward the inside of the casing 16 (inward rotation).

Although not shown, in some embodiments, the shredding device 2 may further include a first motor for rotationally driving one of the drive shafts, a first drive shaft 12A, and a second motor for rotationally driving the other drive shaft, a second drive shaft 12B, separately from the first motor. Although not shown, in some embodiments, the shredding device 2 may further include a first motor for rotationally driving the first drive shaft 12A, while the second drive shaft 12B may be configured to be driven by rotational power transmitted from the first drive shaft 12a.

As illustrated in FIG. 2B, the first drive shaft 12A is provided with a plurality of first-side shredding blades 14A (14). The plurality of first-side shredding blades 14A are arranged at intervals along the extension direction of the first drive shaft 12A. Similarly, the second drive shaft 12B is provided with a plurality of second-side shredding blades 14B (14). The plurality of second-side shredding blades 14B are arranged at intervals along the extension direction of the second drive shaft 12B so as to engage first-side gaps 15A formed by each adjacent first-side shredding blades 14A. The plurality of first-side shredding blades 14A are also arranged so as to engage second-side gaps 15B formed by each adjacent second-side shredding blades 14B.

In the first embodiment, as illustrated in FIGS. 2A and 2B, the shredding device 2 further includes a plurality of claw portions 18 protruding from the inner wall surface 16a of the casing 16. In the top view, the claw portions 18 are provided in the space defined by the inner wall surface 16a of the casing 16, the first drive shaft 12A, and adjacent first-side shredding blades 14A and in the space defined by the inner wall surface 16a of the casing 16, the second drive shaft 12B, and adjacent second-side shredding blades 14B to prevent the unshredded waste W fed into the shredding device 2 from falling. Although not shown, in some embodiments, the shredding device 2 may further include a spacer on the periphery of the first drive shaft 12A in the first-side gap 15A.

The casing 16 has an input port 16b at the top for input of the waste W, and an output port 16c at the bottom for output of the shredded material Wa. The input port 16b is located above the two drive shafts 12A, 12B and the shredding blades 14. The output port 16c is located below the two drive shafts 12A, 12B and the shredding blades 14.

In such a shredding device 2, the waste W fed through the input port 16b is shredded with the shredding blades 14 while passing between the two drive shafts 12A and 12B (shredded material Wa is produced). The shredded material Wa is then discharged from the shredding device 2 through the output port 16c. The setting range R, i.e., the size of the shredded material Wa, is set by adjusting the size of the width 17 of the shredding blades 14. For example, if the width 17 of the shredding blades 14 is adjusted to 80 mm, the setting range R is set between 70 mm and 90 mm. In some embodiments, the lower limit A1 of the setting range R is 50 mm or more and 200 mm or less. In some embodiments, the upper limit of the setting range R is smaller than the inlet of the reforming device 4 for receiving the shredded material Wa.

The reforming device 4 will now be described. The reforming device 4 hydrolyzes the waste W (shredded material Wa) shredded by the shredding device 2 to produce a reformed material X. In the first embodiment, the reforming device 4 hydrolyzes the shredded material Wa with steam in a batch manner. The hydrolysis of the shredded material Wa in the reforming device 4 may be wet hydrolysis in which steam contacts the shredded material Wa and heats the shredded material Wa, or may be dry hydrolysis in which steam indirectly heats the shredded material Wa without contacting the shredded material Wa. In the reforming device 4, the temperature at which the shredded material Wa is hydrolyzed is set according to the use of the reformed material X. For example, when the microbial reaction device 8 is used to degrade a small-particle component X1 into a low-molecular-weight component (in the case of methane fermentation) as described below, the shredded material Wa should be hydrolyzed at a temperature between 100° C. and 180° C. In some embodiments, the reforming device 4 has hydrolysis conditions, including at least one of temperature, pressure, time, and stirring speed, depending on the use of the reformed material X. For example, the hydrolysis conditions include a time between 10 minutes and 60 minutes.

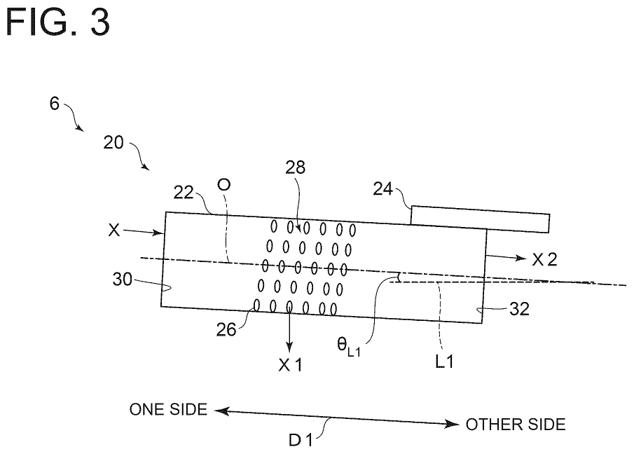

The separation device 6 will now be described. The separation device 6 separates the reformed material X produced by the reforming device 4 into a small-particle component X1 and a large-particle component X2 that has a larger diameter than the small-particle component X1. FIG. 3 is a schematic configuration diagram of the separation device 6 according to the first embodiment.

As illustrated in FIG. 3, in the first embodiment, the separation device 6 includes a sieve 20. The sieve 20 has a mesh size A2, which is smaller than the lower limit A1 of the setting range R. Specifically, A1>4×A2 is satisfied. In the first embodiment, the mesh size A2 is 10 mm or more and 50 mm or less. More specifically, the mesh size A2 is 10 mm or more and 20 mm or less.

In the embodiment illustrated in FIG. 3, the sieve 20 is a so-called trommel, which includes a cylindrical part 22 and a rotating part 24.

The cylindrical part 22 is of cylindrical shape and has an inlet 30 for receiving the reformed material X and an outlet 32 for discharging the large-particle component X2. The inlet 30 is formed by opening one end of the cylindrical part 22. The outlet 32 is formed by opening the other end of the cylindrical part 22. The outlet 32 opens, for example, in a pipe connected to an incineration facility capable of incinerating the reformed material X. The cylindrical part 22 is inclined with respect to the horizontal direction, and the axis O of the cylindrical part 22 extends downward from one end to the other end of the cylindrical part 22. In the first embodiment, the cylindrical part 22 is inclined so that the angle θ_{L1} formed by the axis O and the imaginary straight line L1 extending in the horizontal direction is 0 degrees or more and 5 degrees or less. More specifically, the angle θ_{L1} is 3 degrees.

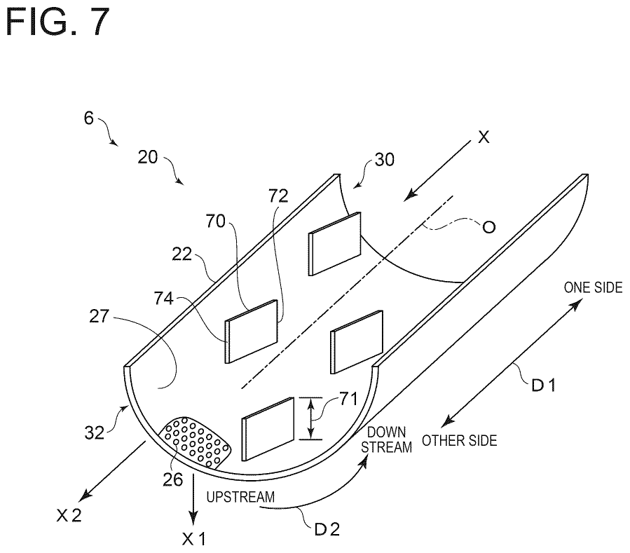

The cylindrical part 22 has a mesh portion 28 in which a plurality of through holes 26 having the mesh size A2 smaller than the lower limit A1 of the setting range R is formed so as to penetrate the inner wall surface 27 (see FIG. 7). In the circumferential direction around the axis O, the mesh portion 28 is provided over the entire circumference of the cylindrical part 22. In the extension direction D1 in which the axis O extends, the mesh portion 28 is provided in a portion of the cylindrical part 22 in the extension direction D1. In this disclosure, the direction from the outlet 32 to the inlet 30 of the cylindrical part 22 is referred to as one side in the extension direction D1, and the direction opposite to the one side in the extension direction DI is referred to as the other side in the extension direction D1.

In some embodiments, the mesh portion 28 may be provided in a portion of the cylindrical part 22 in the circumferential direction. In some embodiments, the mesh portion 28 may be provided in a lower portion of the cylindrical part 22. In some embodiments, the mesh portion 28 may be provided over the entire length of the cylindrical part 22 in the extension direction D1.

The rotating part 24 rotates the cylindrical part 22 around the axis O. The rotating part 24 is, for example, a roller driven to rotate by a motor (not shown) and is disposed in contact with the outer wall surface of the cylindrical part 22. As the roller (rotating part 24) rotates, the cylindrical part 22 rotates.

In such a separation device 6 (trommel), the rotating part 24 rotates the cylindrical part 22, which in turn agitates the reformed material X circulating in the cylindrical part 22 while the mesh portion 28 sieves the material. In other words, the separation device 6 separates substances in the reformed material X that are smaller than the mesh size A2 and pass through the through holes 26 of the mesh portion 28 as the small-particle component X1 from the reformed material X. The separation device 6 discharges substances in the reformed material X that do not pass through the through holes 26 of the mesh portion 28 and remain in the cylindrical part 22 as the large-particle component X2 through the outlet 32 of the cylindrical part 22.

The microbial reaction device 8 will now be described. The microbial reaction device 8 microbially degrades the small-particle component X1 separated by the separation device 6 into a low-molecular-weight component. The microbial reaction device 8 may have any configuration as long as it uses the small-particle component X1 as a raw material and utilizes the biological action of microorganisms to produce valuable resources. For example, the microbial reaction device 8 may be a biogas fermenter for producing biogas such as methane as valuables, a saccharification tank for producing sugar as valuables from carbohydrates such as starch and cellulose, or a composting device for producing compost by composting.

### (Operation and Effect)

The effect of the waste treatment system 1 according to the first embodiment will be described. According to the first embodiment, by shredding the waste W by the shredding device 2, both suitable substances, which are to be degraded by the microbial reaction device 8, and unsuitable substances, which cannot be degraded by the microbial reaction device 8, are cut into similar sizes. Then, by hydrolyzing the shredded material Wa containing such suitable substances and unsuitable substances in the reforming device 4, the suitable substances are fragmented, whereas the unsuitable substances are not as fragmented as the suitable substances. In other words, the reformed material X contains both small-diameter suitable substances and large-diameter unsuitable substances. Therefore, by setting the mesh size A2 in consideration of the difference in the degree of fragmentation, it is possible to improve the accuracy of the separation device 6 that separates the reformed material X into suitable substances (small-particle component X1) and unsuitable substances (large-particle component X2), and it is possible to achieve an improved recovery rate of suitable substances and a reduced mix rate of unsuitable substances in the separation device 6.

According to the first embodiment, the suitable substances can be separated from the reformed material X with high accuracy by simply preparing the sieve 20 with the mesh size A2 smaller than the lower limit A1 of the setting range R.

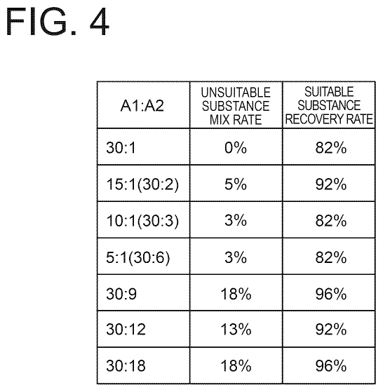

FIG. 4 is a table showing the mix rate of unsuitable substances and the recovery rate of suitable substances corresponding to the ratio of the lower limit A1 of the setting range R to the mesh size A2. The mix rate of unsuitable substances shown in FIG. 4 is calculated by dividing the weight of unsuitable substances that have passed through the through holes 26 by the weight of suitable substances that have passed through the through holes 26. The recovery rate of suitable substances shown in FIG. 4 is calculated by dividing the weight of suitable substances that have passed through the through holes 26 by the weight of suitable substances in the reformed material X.

As shown in FIG. 4, in each of the cases where A1:A2 is 30:1, 15:1, 10:1, and 5:1, the mix rate of unsuitable substances is not more than 5% while ensuring a high recovery rate of suitable substances. The reason for this is that hydrolysis of shredded material Wa enables the size reduction of suitable substances to one-fourth or less, creating a clear difference in size between suitable and unsuitable substances. According to the first embodiment, since A1>4×A2 is satisfied, the passage of unsuitable substances (large-particle component X2) through the through holes 26 is reduced, and a mix rate of unsuitable substances of not more than 5% can be achieved.

According to the findings of the inventors, it is easy to fragment suitable substances into a particle size of 50 mm or less by hydrolysis with a conventional reforming device 4, but it is not easy to fragment suitable substances into a particle size of 10 mm or less. According to the first embodiment, since the mesh size A2 is 10 mm or more and 50 mm or less, a good unsuitable substance mix rate (not more than 5%) can be achieved in the waste treatment system 1 with a conventional reforming device 4.

It may be recommended that the shredded material Wa input to the reforming device 4 is within a size range of 50 mm or more and 200 mm or less. According to some embodiments, since the lower limit A1 of the setting range R is 50 mm or more and 200 mm or less, the shredded material Wa with an appropriate size for operation of the reforming device 4 can be input while ensuring a good unsuitable substance mix rate.

After hydrolysis, the suitable substances have increased moisture and may adhere to unsuitable substances. According to the first embodiment, the rotation of the cylindrical part 22 causes the reformed material X in the cylindrical part 22 to rotate and fall, thereby separating the adhering suitable substances from the unsuitable substances and discharging them out of the cylindrical part 22 through the through holes 26. Thus, it is possible to improve the recovery rate of suitable substances. Additionally, since the rotation of the cylindrical part 22 also rotates the through holes 26 around the axis O, unsuitable substances are prevented from continuously blocking the through holes 26.

In the first embodiment, the separation device 6 is a rotary sieve 20, so-called trommel, but the present disclosure is not limited to this embodiment. The separation device 6 may be a vibrating sieve 20 that separates the reformed material X into the small-particle component X1 and the large-particle component X2 by vibrating a mesh member, such as wire mesh, in the horizontal direction. The separation device 6 may be a device other than the sieve 20, for example, an air classifier that separates the small-particle component X1 and the large-particle component X2 by air flow.

In the first embodiment, the setting range R (size of shredded material Wa) is set by adjusting the size of the width 17 of the shredding blades 14, but the present disclosure is not limited to this embodiment. For example, the setting range R may be set by adjusting the diameter of the output port 16c of the casing 16 or the inlet of the reforming device 4.

### Second Embodiment

The waste treatment system 1 according to the second embodiment of the present disclosure will be described. The second embodiment differs from the first embodiment in that the waste treatment system 1 further includes a control device 50 and an imaging device 60, and the sieve 20 has a lid part 40. In the second embodiment, the same constituent elements as those in the first embodiment are associated with the same reference characters and thus not described again in detail.

### (Configuration)

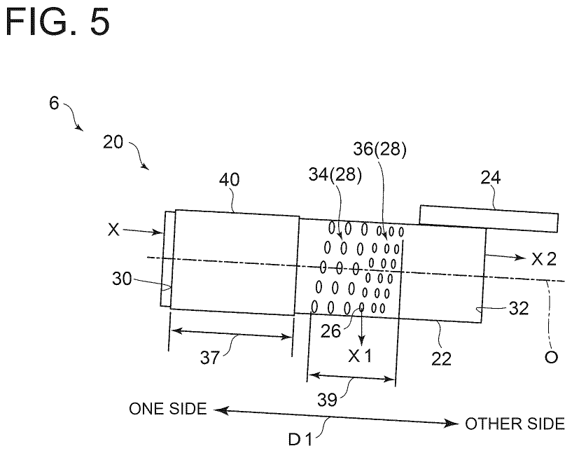

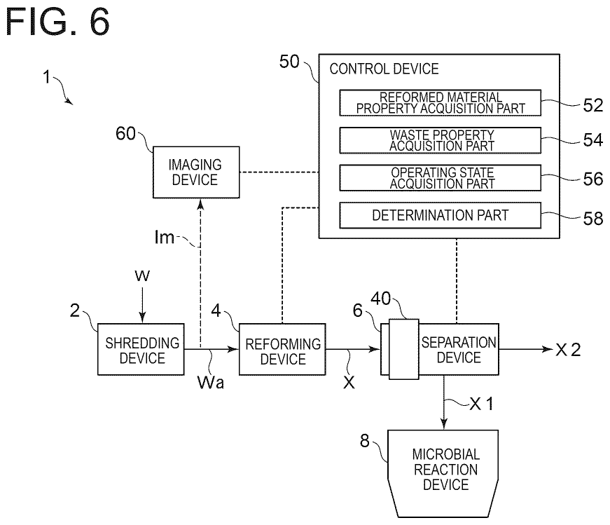

FIG. 5 is a schematic configuration diagram of the sieve 20 (separation device 6) according to the second embodiment. FIG. 6 is a schematic configuration diagram of the waste treatment system 1 according to the second embodiment. In the second embodiment, as illustrated in FIG. 5, the cylindrical part 22 of the sieve 20 includes a first mesh portion 34 (28) and a second mesh portion 36 (28). The first mesh portion 34 is located closer to the inlet 30 of the cylindrical part 22 than the second mesh portion 36 is. The second mesh portion 36 has a through hole 26 with a smaller diameter than that in the first mesh portion 34.

The sieve 20 further includes a lid part 40 disposed outside the cylindrical part 22. This lid part 40 covers each of the first mesh portion 34 and the second mesh portion 36 openably and closably. In the embodiment illustrated in FIG. 5, the lid part 40 is a cylindrical member with an inner diameter larger than the outer diameter of the cylindrical part 22 and surrounds the cylindrical part 22. The length 37 of the lid part 40 in the extension direction DI is longer than the length 39 from one end of the first mesh portion 34 on one side in the extension direction D1 to the other end of the second mesh portion 36 on the other side in the extension direction D1. The lid part 40 is configured to be movable along the extension direction DI by a driving force supplied from a driving source (not shown). Thus, the lid part 40 can close both the first mesh portion 34 and the second mesh portion 36 and close either the first mesh portion 34 or the second mesh portion 36.

In the second embodiment, as illustrated in FIG. 6, the waste treatment system 1 further includes a control device 50 and an imaging device 60.

The control device 50 is a computer such as an electronic control device, and includes a processor such as CPU or GPU, a memory such as ROM or RAM, an I/O interface and the like (all of which are not shown). The processor executes operation (such as calculation) in accordance with a program instruction loaded to the memory, and whereby the control device 50 implements each functional unit of the control device 50. In some embodiments, the control device 50 is a cloud server installed in a cloud environment.

The imaging device 60 images the shredded material Wa to obtain an image Im of the shredded material Wa. The imaging device 60 is electrically connected to the control device 50 and transmits the image Im of the shredded material Wa to the control device 50. The imaging device 60 may be a device capable of acquiring image information corresponding to multiple wavelengths, for example, a multispectral camera or hyperspectral camera. This imaging device 60 captures images not only in the visible light region, but also in the near-infrared region.

The functional units of the control device 50 according to the second embodiment will be described with reference to FIG. 6. In the second embodiment, as illustrated in FIG. 6, the control device 50 includes a reformed material property acquisition part 52, a waste property acquisition part 54, an operating state acquisition part 56, and a determination part 58.

The reformed material property acquisition part 52 acquires the properties of the reformed material X on the basis of the properties of the waste W and hydrolysis conditions under which the shredded material Wa is hydrolyzed in the reforming device 4. The properties of the waste W are, for example, the moisture content of the waste W and the composition of the waste W. The hydrolysis conditions are, for example, temperature, pressure, and holding time. The properties of the reformed material X are, for example, the moisture content of the reformed material X and the composition of the reformed material X. The properties of the waste W and the hydrolysis conditions may be information stored in advance in the control device 50 or other devices, or may be obtained during the operation of the waste treatment system 1.

The waste property acquisition part 54 acquires the properties of the waste W on the basis of the image Im of the shredded material Wa captured by the imaging device 60. An example of the method to acquire the composition of the waste W will be described below. The image Im with unsuitable substances (e.g., plastics) contains image information corresponding to a predetermined wavelength range, and the weight of the unsuitable substances can be estimated from this image information. Similarly, the image Im with suitable substances (e.g., food, paper, and biomass) contains image information corresponding to a predetermined wavelength range (different from that of plastics), and the weight of the suitable substances can be estimated from this image information. The waste property acquisition part 54 identifies the composition of the waste W from the weights of unsuitable and suitable substances.

The operating state acquisition part 56 acquires the operating state of the reforming device 4. As illustrated in FIG. 6, the control device 50 is electrically connected to the reforming device 4, and the operating state acquisition part 56 can acquire the operating state of the reforming device 4 in real time.

The determination part 58 determines whether the small-particle component X1 contained in the reformed material X is suitable for degradation by the microbial reaction device 8 on the basis of the properties of the reformed material X acquired by the reformed material property acquisition part 52. Further, the determination part 58 determines whether the small-particle component X1 contained in the reformed material X is suitable for degradation by the microbial reaction device 8 on the basis of the properties of the waste W acquired by the waste property acquisition part 54. Further, the determination part 58 determines that the small-particle component X1 contained in the reformed material X produced by the reforming device 4 is unsuitable for degradation by the microbial reaction device 8 when the operating state of the reforming device 4 acquired by the operating state acquisition part 56 is a maintenance state in which the reforming device 4 is under maintenance. On the other hand, the determination part 58 determines that the small-particle component X1 contained in the reformed material X produced by the reforming device 4 is suitable for degradation by the microbial reaction device 8 when the operating state of the reforming device 4 acquired by the operating state acquisition part 56 is a state other than the maintenance state.

The lid part 40 is configured to open the mesh portion 28 when the small-particle component X1 is determined by the determination part 58 to be suitable for degradation. On the other hand, the lid part 40 is configured to close the mesh portion 28 when the small-particle component X1 is determined by the determination part 58 to be unsuitable for degradation. In the second embodiment, as shown in FIG. 6, the separation device 6 is electrically connected to the control device 50. The control device 50 transmits an instruction to the separation device 6 to open the mesh portion 28 when the small-particle component X1 is determined by the determination part 58 to be suitable for degradation. On the other hand, the control device 50 transmits an instruction to the separation device 6 to close the mesh portion 28 when the small-particle component X1 is determined by the determination part 58 to be unsuitable for degradation. The separation device 6 moves the lid part 40 according to the instructions of the control device 50.

In the second embodiment, the control device 50 calculates the particle size of the small-particle component X1 from the setting range R and the hydrolysis conditions, and on the basis of the particle size of the small-particle component X1, transmits an instruction to the separation device 6 to open or close one of the first mesh portion 34 and the second mesh portion 36.

### (Operation and Effect)

The effect of the waste treatment system 1 according to the second embodiment will be described. According to the second embodiment, the sieve 20 can be used as a conveying line for conveying the reformed material X by closing the mesh portion 28 with the lid part 40 when it is unnecessary to separate the reformed material X into the suitable and unsuitable substances.

According to the second embodiment, since the cylindrical part 22 of the sieve 20 includes the first mesh portion 34 and the second mesh portion 36 in which the through hole 26 with a smaller diameter than that in the first mesh portion 34 is formed, it is possible to expand the range of particle sizes of the small-particle component X1 (suitable substances) that can be separated by the sieve 20. The degree of fragmentation of the suitable substances depends on the hydrolysis conditions, but even if the hydrolysis conditions are changed, the sieve 20 does not need to be replaced. Furthermore, according to the second embodiment, since the first mesh portion 34 is located closer to the inlet 30 of the cylindrical part 22 than the second mesh portion 36 is, the reformed material X can be separated into large-diameter suitable substances and small-diameter suitable substances.

According to the second embodiment, it is determined whether the small-particle component X1 is suitable for degradation by the microbial reaction device 8 on the basis of at least one of the properties of the waste W, the properties of the reformed material X, and the operating state of the reforming device 4. If it is determined to be suitable for degradation, the small-particle component X1 is separated from the reformed material X by the sieve 20, and the small-particle component X1 is supplied to the microbial reaction device 8. On the other hand, if it is determined to be unsuitable for degradation, the small-particle component X1 is not separated from the reformed material X by the sieve 20, and the small-particle component X1 is not supplied to the microbial reaction device 8. Therefore, it is possible to maintain the microbial reaction device 8 in a state suitable for degradation.

In the second embodiment, the lid part 40 surrounds the cylindrical part 22 and is configured to be movable along the extension direction D1, but the present disclosure is not limited to this embodiment. The lid part 40 may surround a portion of the cylindrical part 22. The lid part 40 may be configured to be movable along the circumferential direction.

### Third Embodiment

The waste treatment system 1 according to the third embodiment of the present disclosure will be described. The third embodiment differs from the first embodiment in that the sieve 20 further includes a guide part 70. In the third embodiment, the same constituent elements as those in the first embodiment are associated with the same reference characters and thus not described again in detail. In some embodiments, the sieve 20 of the second embodiment further includes a guide part 70.

(Configuration) FIG. 7 is a perspective view of part of the inside of the sieve 20 according to the third embodiment, with the sieve 20 being cut along the extension direction D1. In the third embodiment, the direction in which the cylindrical part 22 rotates (the direction of counterclockwise rotation on the paper in FIG. 7) is referred to as the rotational direction D2.

As illustrated in FIG. 7, the sieve 20 further includes a plate-like guide part 70 disposed on the inner wall surface 27 of the cylindrical part 22. The guide part 70 extends along the extension direction D1. One end 72 of the guide part 70 on one side in the extension direction D1 (the side closer to the inlet 30 of the cylindrical part 22) is located downstream of the other end 74 of the guide part 70 on the other side in the extension direction D1 (the side closer to the outlet 32 of the cylindrical part 22) in the rotational direction D2. A plurality of the guide parts 70 may be disposed on the inner wall surface 27 of the cylindrical part 22 (see FIG. 7), or a single guide part 70 may be disposed.

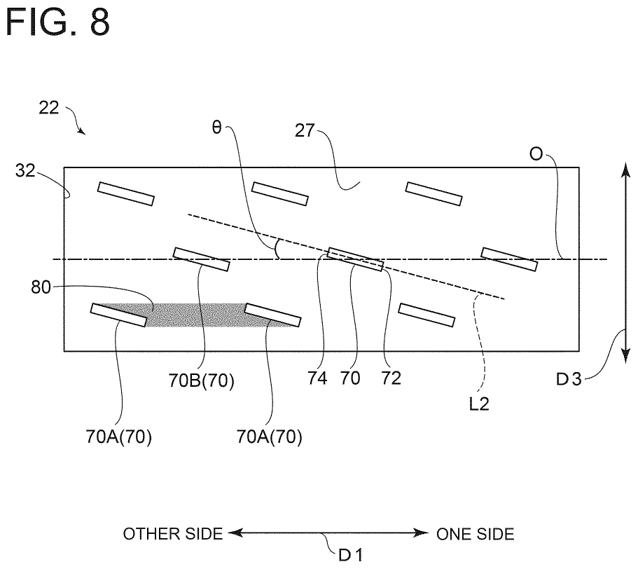

FIG. 8 is a diagram for describing the guide part 70 according to the third embodiment when the inside of the cylindrical part 22 is viewed in the radial direction.

As illustrated in FIG. 8, the guide part 70 satisfies 5 degrees<θ<25 degrees, where θ is an angle formed by an imaginary line L2 passing through the one end 72 of the guide part 70 and the other end 74 of the guide part 70 and the axis O of the cylindrical part 22.

In the embodiment illustrated in FIG. 8, the inner wall surface 27 of the cylindrical part 22 is provided with a plurality of guide parts 70. The plurality of guide parts 70 includes two first line guide parts 70A (70) and 70A (70), which are spaced apart from each other along the extension direction D1, and a second line guide part 70B (70), which is located between the two first line guide parts 70A and 70A in the extension direction D1 and is displaced from a region 80 defined by the two first line guide parts 70A and 70A in the circumferential direction D3. In the embodiment illustrated in FIG. 8, a plurality of the second line guide parts 70B are provided, and the plurality of second line guide parts 70B are arranged at intervals in the extension direction D1. The first line guide parts 70A and the second line guide parts 70B are arranged offset from each other in the extension direction DI (they are in a so-called staggered arrangement).

### (Operation and Effect)

According to the third embodiment, when the guide part 70 moves upward by the rotation of the cylindrical part 22, the reformed material X on the guide part 70 can move toward the outlet 32 of the cylindrical part 22 since the one end 72 of the guide part 70 is located above the other end 74.

By increasing the retention time for the reformed material X to remain in the cylindrical part 22, the recovery rate of suitable substances (small-particle component X1) can be improved. According to the findings of the inventors, when θ is smaller than 5 degrees, the reformed material X is hardly conveyed, and when θ is larger than 25 degrees, the retention time is short, and the recovery rate of suitable substances is low. According to the third embodiment, the inclination of the guide part 70 satisfying 5 degrees<θ<25 degrees allows the retention time to increase, thereby improving the recovery rate of suitable substances (small-particle component X1).

According to the third embodiment, the first line guide parts 70A and the second line guide parts 70B are in a staggered arrangement to facilitate smooth conveyance of the reformed material X.

In some embodiments, as shown in FIG. 7, the guide part 70 has a length 71 (height) in the radial direction around the axis O between ½ and 3/2 the size of the reformed material X. With this configuration, it is possible to prevent the reformed material X from collapsing to one side in the extension direction D1 before the reformed material X is lifted to a certain height by the rotation of the cylindrical part 22. The size of the reformed material X is, for example, the measured length of the reformed material X in the direction of gravity when the reformed material X is left to stand (i.e., not supported or grasped, but placed on the ground).

The contents described in the above embodiments would be understood as follows, for instance.

[1] A waste treatment system (1) according to the present disclosure includes: a shredding device (2) for shredding a waste (W) into a size within a setting range (R) set in advance; a reforming device (4) for producing a reformed material (X) by hydrolyzing the waste shredded by the shredding device; a separation device (6) for separating the reformed material produced by the reforming device into a small-particle component (X1) and a large-particle component (X2) that has a larger diameter than the small-particle component; and a microbial reaction device (8) for microbially degrading the small-particle component separated by the separation device into a low-molecular-weight component.

With the above configuration [1], by shredding the waste by the shredding device, both suitable substances of the waste, which are to be degraded by the microbial reaction device, and unsuitable substances of the waste, which cannot be degraded by the microbial reaction device, are cut into similar sizes. Then, by hydrolyzing the waste containing such suitable and unsuitable substances in the reforming device, the suitable substances are fragmented, whereas the unsuitable substances are not as fragmented as the suitable substances. In other words, the reformed material contains both small-diameter suitable substances and large-diameter unsuitable substances. Therefore, the accuracy of the separation device that separates the reformed material into suitable substances and unsuitable substances by considering the difference in the degree of fragmentation can be improved, and a good recovery rate of suitable substances and a good mix rate of unsuitable substances can be achieved in the separation device.

[2] In some embodiments, in the above configuration [1], the separation device includes a sieve (20), and the sieve has a mesh size that is smaller than the setting range.

With the above configuration [2], the mix rate of unsuitable substances can be reduced by simply preparing a sieve with a mesh size smaller than the setting range.

[3] In some embodiments, in the above configuration [2], A1>4×A2 is satisfied, where A1 is a lower limit of the setting range, and A2 is the mesh size of the sieve.

According to the inventors, hydrolysis of waste enables the size reduction of suitable substances to one-fourth or less, creating a clear difference in size between suitable and unsuitable substances. Thus, with the above configuration [3], it is possible to achieve a very low mix rate of unsuitable substances.

[4] In some embodiments, in the above configuration [2] or [3], the mesh size of the sieve is 10 mm or more and 50 mm or less.

According to the findings of the inventors, it is easy to fragment suitable substances into a particle size of 50 mm or less by hydrolysis with a conventional reforming device, but it is not easy to fragment suitable substances into a particle size of 10 mm or less. With the above configuration [4], it is possible to achieve a good mix rate of unstable substances using a conventional reforming device.

[5] In some embodiments, in any one of the above configurations [2] to [4], the sieve includes: a cylindrical part (22) of cylindrical shape having at least one mesh portion (28) in which a through hole (26) having the mesh size is formed so as to penetrate an inner wall surface (27) of the cylindrical part; and a rotating part (24) for rotating the cylindrical part around an axis (O) of the cylindrical part.

After hydrolysis, the suitable substances have increased moisture and may adhere to unsuitable substances. With the above configuration [5], the rotation of the cylindrical part causes the reformed material to rotate and fall, thereby separating the adhering suitable substances from the unsuitable substances and discharging them out of the cylindrical part through the through hole. Thus, it is possible to improve the recovery rate of suitable substances. Additionally, since the through hole is also rotated, unsuitable substances are prevented from continuously blocking the through hole.

[6] In some embodiments, in the above configuration [5], the sieve further includes a lid part (40) disposed outside the cylindrical part and openably and closably covering the mesh portion.

With the above configuration [6], the sieve can be used as a conveying line for the reformed material by closing the mesh portion with the lid part when it is unnecessary to separate the reformed material into the suitable and unsuitable substances.

[7] In some embodiments, in the above configuration [6], the waste treatment system further includes: a reformed material property acquisition part (52) for acquiring properties of the reformed material on the basis of properties of the waste and hydrolysis conditions under which the waste shredded by the shredding device is hydrolyzed in the reforming device; and a determination part (58) for determining whether the small-particle component is suitable for degradation by the microbial reaction device on the basis of the properties of the reformed material acquired by the reformed material property acquisition part. The lid part is configured to open the mesh portion when the small-particle component is determined by the determination part to be suitable for degradation, and to close the mesh portion when the small-particle component is determined by the determination part to be unsuitable for degradation.

With the above configuration [7], the properties of the reformed material are acquired based on the properties of the waste and the hydrolysis conditions. If the small-particle component determined based on the properties of the reformed material is suitable for degradation, the small-particle component is separated from the reformed material by the sieve, and the small-particle component is supplied to the microbial reaction device. On the other hand, if the small-particle component determined based on the properties of the reformed material is unsuitable for degradation, the small-particle component is not separated from the reformed material by the sieve, and the small-particle component is not supplied to the microbial reaction device. Therefore, it is possible to maintain the microbial reaction device in a state suitable for degradation.

[8] In some embodiments, in the above configuration [6] or [7], the waste treatment system further includes: an imaging device (60) for capturing an image of the waste shredded by the shredding device; a waste property acquisition part (54) for acquiring properties of the waste on the basis of the image of the waste captured by the imaging device; and a determination part (58) for determining whether the small-particle component is suitable for degradation by the microbial reaction device on the basis of the properties of the waste acquired by the waste property acquisition part. The lid part is configured to open the mesh portion when the small-particle component is determined by the determination part to be suitable for degradation, and to close the mesh portion when the small-particle component is determined by the determination part to be unsuitable for degradation.

With the above configuration [8], the properties of the waste are acquired based on the image of the waste. If the small-particle component determined based on the properties of the reformed material is suitable for degradation, the small-particle component is separated from the reformed material by the sieve, and the small-particle component is supplied to the microbial reaction device. On the other hand, if the small-particle component determined based on the properties of the reformed material is unsuitable for degradation, the small-particle component is not separated from the reformed material by the sieve, and the small-particle component is not supplied to the microbial reaction device. Therefore, it is possible to maintain the microbial reaction device in a state suitable for degradation.

[9] In some embodiments, in any one of the above configurations [6] to [8], the waste treatment system further includes: an operating state acquisition part (56) for acquiring an operating state of the reforming device; and a determination part (58) for determining that the small-particle component is unsuitable for degradation by the microbial reaction device when the operating state of the reforming device acquired by the operating state acquisition part is a maintenance state in which the reforming device is under maintenance, and determining that the small-particle component is suitable for degradation by the microbial reaction device when the operating state of the reforming device acquired by the operating state acquisition part is a state other than the maintenance state. The lid part is configured to open the mesh portion when the small-particle component is determined by the determination part to be suitable for degradation, and to close the mesh portion when the small-particle component is determined by the determination part to be unsuitable for degradation.

With the above configuration [9], when the reforming device is not in the maintenance state, the sieve separates the suitable substances from the reformed material, and the suitable substances are supplied to the microbial reaction device. On the other hand, if the reforming device is in the maintenance state, the sieve does not separate the suitable substances from the reformed material, and the suitable substances are not supplied to the microbial reaction device. Therefore, it is possible to maintain the microbial reaction device in a state suitable for degradation.

[10] In some embodiments, in any one of the above configurations [5] to [9], the cylindrical part has an inlet (30) at one end for receiving the reformed material. The at least one mesh portion includes a first mesh portion (34), and a second mesh portion (36) in which the through hole with a smaller diameter than that in the first mesh portion is formed. In an extension direction (D1) in which the cylindrical part extends, the first mesh portion is located closer to the inlet of the cylindrical part than the second mesh portion is.

With the above configuration [10], it is possible to expand the range of particle sizes of suitable substances that can be separated by the sieve. The degree of fragmentation of the suitable substances depends on the hydrolysis conditions, but even if the hydrolysis conditions are changed, the sieve does not need to be replaced. Furthermore, with the above configuration [10], since the first mesh portion is located closer to the inlet of the cylindrical part than the second mesh portion is, the reformed material can be separated into large-diameter suitable substances and small-diameter suitable substances.

[11] In some embodiments, in any one of the above configurations [5] to [10], the sieve further includes a plate-like guide part (70) disposed on the inner wall surface of the cylindrical part and extending along an extension direction (D1) in which the cylindrical part extends. The cylindrical part has an inlet (30) at one end for receiving the reformed material. In a rotational direction (D3) of the cylindrical part, one end (72) of the guide part closer to the inlet in the extension direction is located downstream of the other end (74) of the guide part opposite the inlet in the extension direction.

With the above configuration [11], the rotation of the cylindrical part can move the reformed material in the cylindrical part toward the side opposite the inlet of the cylindrical part in the extension direction.

[12] In some embodiments, in the above configuration [11], 5 degrees<θ<25 degrees is satisfied, where θ is an angle formed by an imaginary line (L2) passing through the one end of the guide part and the other end of the guide part and the axis of the cylindrical part when the guide part is viewed from a radially outer side of the cylindrical part.

By increasing the retention time for the reformed material to remain in the cylindrical part, the recovery rate of suitable substances can be improved. With the above configuration [12], the rotation of the cylindrical part moves the reformed material in the cylindrical part toward the side opposite the inlet of the cylindrical part in the extension direction, while the inclination of the guide part satisfying 5 degrees<θ<25 degrees allows the retention time to increase, thereby improving the recovery rate of suitable substances.

### REFERENCE SIGNS LIST

1 Waste treatment system
2 Shredding device
4 Reforming device
6 Separation device
8 Microbial reaction device
20 Sieve
22 Cylindrical part
24 Rotating part
26 Through hole
27 Inner wall surface of cylindrical part
28 Mesh portion
30 Inlet of cylindrical part
32 Outlet of cylindrical part
34 First mesh portion
36 Second mesh portion
40 Lid part
50 Control device
52 Reformed material property acquisition part
54 Waste property acquisition part
56 Operating state acquisition part
58 Determination part
60 Imaging device
70 Guide part
72 One end of guide part
74 Other end of guide part
A1 Lower limit of setting range
A2 Mesh size
D1 Extension direction
D2 Rotational direction
D3 Circumferential direction
Im Image
L1 Straight line
L2 Imaginary line
θ Axis
R Setting range
W Waste
Wa Shredded material
X Reformed material
X1 Small-particle component
X2 Large-particle component

1. A waste treatment system, comprising:
a shredding device for shredding a waste into a size within a setting range set in advance;
a reforming device for producing a reformed material by hydrolyzing the waste shredded by the shredding device;
a separation device for separating the reformed material produced by the reforming device into a small-particle component and a large-particle component that has a larger diameter than the small-particle component; and
a microbial reaction device for microbially degrading the small-particle component separated by the separation device into a low-molecular-weight component.

2. The waste treatment system according to claim 1,
wherein the separation device includes a sieve, and
wherein the sieve has a mesh size that is smaller than the setting range.

3. The waste treatment system according to claim 2, wherein A1>4×A2 is satisfied, where A1 is a lower limit of the setting range, and A2 is the mesh size of the sieve.

4. The waste treatment system according to claim 2, wherein the mesh size of the sieve is 10 mm or more and 50 mm or less.

5. The waste treatment system according to claim 2, wherein the sieve includes:
a cylindrical part of cylindrical shape having at least one mesh portion in which a through hole having the mesh size is formed so as to penetrate an inner wall surface of the cylindrical part; and
a rotating part for rotating the cylindrical part around an axis of the cylindrical part.

6. The waste treatment system according to claim 5,
wherein the sieve further includes a lid part disposed outside the cylindrical part and openably and closably covering the mesh portion.

7. The waste treatment system according to claim 6, further comprising:
a reformed material property acquisition part for acquiring properties of the reformed material based on properties of the waste and hydrolysis conditions under which the waste shredded by the shredding device is hydrolyzed in the reforming device; and
a determination part for determining whether the small-particle component is suitable for degradation by the microbial reaction device based on the properties of the reformed material acquired by the reformed material property acquisition part,
wherein the lid part is configured to open the mesh portion when the small-particle component is determined by the determination part to be suitable for degradation, and to close the mesh portion when the small-particle component is determined by the determination part to be unsuitable for degradation.

8. The waste treatment system according to claim 6, further comprising:
an imaging device for capturing an image of the waste shredded by the shredding device;
a waste property acquisition part for acquiring properties of the waste based on the image of the waste captured by the imaging device; and
a determination part for determining whether the small-particle component is suitable for degradation by the microbial reaction device based on the properties of the waste acquired by the waste property acquisition part,
wherein the lid part is configured to open the mesh portion when the small-particle component is determined by the determination part to be suitable for degradation, and to close the mesh portion when the small-particle component is determined by the determination part to be unsuitable for degradation.

9. The waste treatment system according to claim 6, further comprising:
an operating state acquisition part for acquiring an operating state of the reforming device; and
a determination part for determining that the small-particle component is unsuitable for degradation by the microbial reaction device when the operating state of the reforming device acquired by the operating state acquisition part is a maintenance state in which the reforming device is under maintenance, and determining that the small-particle component is suitable for degradation by the microbial reaction device when the operating state of the reforming device acquired by the operating state acquisition part is a state other than the maintenance state,
wherein the lid part is configured to open the mesh portion when the small-particle component is determined by the determination part to be suitable for degradation, and to close the mesh portion when the small-particle component is determined by the determination part to be unsuitable for degradation.

10. The waste treatment system according to claim 5,
wherein the cylindrical part has an inlet at one end for receiving the reformed material,
wherein the at least one mesh portion includes a first mesh portion, and a second mesh portion in which the through hole with a smaller diameter than that in the first mesh portion is formed, and
wherein, in an extension direction in which the cylindrical part extends, the first mesh portion is located closer to the inlet of the cylindrical part than the second mesh portion is.

11. The waste treatment system according to claim 5,
wherein the sieve further includes a plate-like guide part disposed on the inner wall surface of the cylindrical part and extending along an extension direction in which the cylindrical part extends,
wherein the cylindrical part has an inlet at one end for receiving the reformed material, and
wherein, in a rotational direction of the cylindrical part, one end of the guide part closer to the inlet in the extension direction is located downstream of an other end of the guide part opposite the inlet in the extension direction.

12. The waste treatment system according to claim 11,
wherein 5 degrees<θ<25 degrees is satisfied, where θ is an angle formed by an imaginary line passing through the one end of the guide part and the other end of the guide part and the axis of the cylindrical part when the guide part is viewed from a radially outer side of the cylindrical part.
